(19) United States
(12) Patent Application Publication
(10) Pub. No.: US 2023/0164087 A1
(43) Pub. Date: May 25, 2023

(54) CONTROL SYSTEM AND CONTROL METHOD

(71) Applicant: NIPPON TELEGRAPH AND TELEPHONE CORPORATION, Tokyo (JP)

(72) Inventors: Yushi KOYASAKO, Musashino-shi, Tokyo (JP); Takashi YAMADA, Musashino-shi, Tokyo (JP)

(73) Assignee: NIPPON TELEGRAPH AND TELEPHONE CORPORATION, Tokyo (JP)

(21) Appl. No.: 17/912,955

(22) PCT Filed: Mar. 24, 2020
(86) PCT No.: PCT/JP2020/012991

§ 371 Date: Sep. 20, 2022

(51) Int. Cl. H04L 47/36; H04L 43/087

(52) U.S. Cl. CPC H04L 47/36; H04L 43/087

(57) ABSTRACT

A control system includes a control device that controls a control target device; and one or more communication devices that execute communication processing between the control target device and the control device. Each of the communication devices includes a division determination unit that determines whether data used for controlling the control target device per a certain cycle has been divided into a plurality of cycles each being the certain cycle; and a control unit that, when it is determined that the data used for control per the cycle has been divided, sets a size of a packet to be increased so that data required for control per the cycle is contained in the packet, or sets a length of a burst frame to be increased so that data required for control per the cycle is contained in the burst frame.

### TECHNICAL FIELD

The present invention relates to a control system and a control method.

### BACKGROUND ART

A time delay in communication processing in a communication network may adversely affect the performance of real-time control of a terminal of the Internet of Things (IoT) (hereinafter referred to as “IoT terminal”). For example, as the time delay in communication processing increases, the time required to stabilize the control system (hereinafter referred to as “settling time”) may increase, deteriorating the performance of real-time control. Further, for example, as the time delay in communication processing increases, the settling time of the control system in the communication network may increase, causing the IoT terminal to be out of control.

In general, the longer the distance between a device under control as defined (hereinafter referred to as “control target device”) and a control device that controls the control target device is, the longer the time delay in communication processing becomes. Further, the larger the number of communication devices that are passed through in a communication between the control target device and the control device, the longer the time delay in communication processing becomes.

In recent years, techniques related to edge computing have been proposed. In edge computing, a control device is installed in the vicinity of a control target device to control the control target device, so that the time delay in communication processing can be shortened.

However, not only the length of the time delay but also the jitter (variation) of the time delay adversely affects the performance of the real-time control of the control target device. For example, the time delay in communication processing in the communication device on the station building side changes according to the changes in the communication band, the number of communication devices, and the communication protocol in the communication network. This causes jitter in the time delay in communication processing between the control target device and the control target device. Therefore, in real-time control of the control target device, it is necessary to reduce the jitter of the time delay.

Further, PTL 1 discloses a network management device that aims at setting a buffer size so as to shorten the time delay. Further, PTL 2 discloses a bandwidth allocation device that aims at setting a cycle time for dynamic bandwidth allocation (DBA) so as to achieve both a time delay and a bandwidth utilization efficiency.

### CITATION LIST

### Patent Literature

[PTL 1] Japanese Patent Application Publication No. 2014-138307
[PTL 2] Japanese Patent Application Publication No. 2016-111582

### SUMMARY OF THE INVENTION

### Technical Problem

However, in the conventional control systems, it may not be possible to reduce the time delay in communication processing in a communication network and the jitter of the time delay. For example, the network management device according to PTL 1 does not cover any optical access network, so that it is not possible to reduce the time delay in communication processing and the jitter of the time delay in an optical access network. Further, for example, the bandwidth allocation device according to PTL 2 is not directed to the real-time control of an IoT terminal and does also not consider the jitter due to the change in the state of a communication network, so that it is not possible to reduce the jitter of the time delay in communication processing in the communication network.

In view of the above circumstances, an object of the present invention is to provide a control system and a control method which are capable of reducing at least one of the time delay in communication processing and the jitter of the time delay in a communication network.

### Means for Solving the Problem

One aspect of the present invention is a control system including a control device that controls a control target device; and one or more communication devices that execute communication processing between the control target device and the control device. Each of the communication devices includes a division determination unit that determines whether data used for controlling the control target device per a certain cycle has been divided into a plurality of cycles each being the certain cycle; and a control unit that, when it is determined that the data used for control per the cycle has been divided, sets a size of a packet to be increased so that data required for control per the cycle is contained in the packet, or sets a length of a burst frame to be increased so that data required for control per the cycle is contained in the burst frame.

One aspect of the present invention is a control method performed by a control system including a control device that controls the above-mentioned control target device; and one or more communication devices that execute communication processing between the control target device and the control device. The control method includes a division determination step of, by each of the communication devices, determining whether data used for controlling the control target device per a certain cycle has been divided into a plurality of cycles each being the certain cycle; and a control step of, by each of the communication devices, when it is determined that the data used for control per the cycle has been divided, setting a size of a packet to be increased so that data required for control per the cycle is contained in the packet, or setting a length of a burst frame to be increased so that data required for control per the cycle is contained in the burst frame.

### Effects of the Invention

According to the present invention, it is possible to reduce at least one of the time delay in communication processing and the jitter of the time delay in a communication network.

### BRIEF DESCRIPTION OF DRAWINGS

FIG. 1 is a diagram illustrating a configuration example of a control system according to a first embodiment.

FIG. 2 is a diagram illustrating a configuration example of a first communication device according to the first embodiment.

FIG. 3 illustrates an example of a relationship between packet size and settling time in the first embodiment.

FIG. 4 illustrates an example of a relationship between data size and packet size in the first embodiment.

FIG. 5 is a flowchart illustrating an operation example of the control system according to the first embodiment.

FIG. 6 is a diagram illustrating a configuration example of a control system according to a second embodiment.

FIG. 7 is a diagram illustrating a configuration example of a second communication device according to the second embodiment.

FIG. 8 illustrates an example of a relationship between burst frame size and settling time in the second embodiment.

FIG. 9 illustrates an example of a relationship between data size and burst frame size in the second embodiment.

FIG. 10 is a flowchart illustrating an operation example of the control system according to the second embodiment.

FIG. 11 is a diagram illustrating a configuration example of a control system according to a third embodiment.

### DESCRIPTION OF EMBODIMENTS

Embodiments of the present invention will be described in detail with reference to the drawings.

### First Embodiment

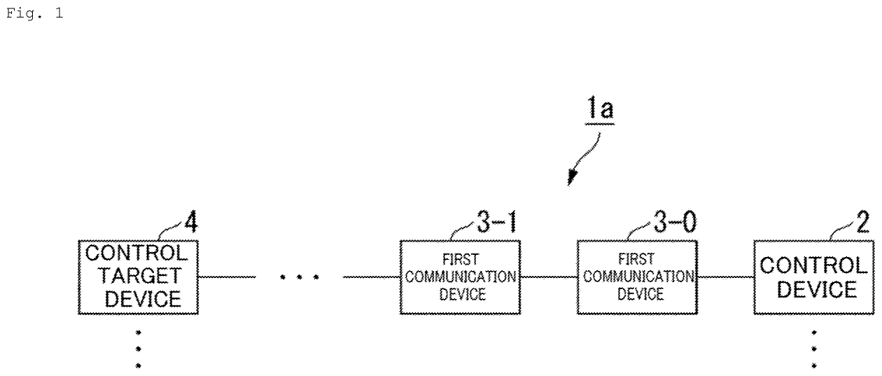

FIG. 1 is a diagram illustrating a configuration example of a control system 1a according to a first embodiment. The control system 1a is a system that executes real-time control of a control target device such as an IoT terminal. The control system 1a executes motion control of the control target device in real time.

The control system 1a includes one or more control devices 2, one or more first communication devices 3, and one or more control target devices 4. In the first embodiment, a control device 2, one or more first communication devices 3, and a control target device 4 form a single star (SS) network as an example.

Hereinafter, the direction from the control device 2 toward the control target device 4 is referred to as “downlink”. The direction from the control target device 4 to the control device 2 is referred to as “uplink”. Hereinafter, uplink data used for control and downlink data used for control are collectively referred to as “data used for control”.

The control device 2 is a device that controls the control target device 4. The control device 2 acquires from the first communication device 3 certain data transmitted in uplink from the control target device 4 as uplink data used for controlling the control target device 4. The certain data may be, for example, sensor data generated by the control target device 4 or image data generated by the control target device 4. This image data may be still image data or moving image data having a predetermined frame rate.

In order to control the control target device 4, the control device 2 generates instruction data based on the certain data as uplink data used for controlling the control target device 4. The instruction data includes, for example, a code number indicating the type of instruction. The instruction data may include control data such as a setting value used for controlling the control target device 4. The setting value may be, for example, a value representing the operating amount of the IoT terminal, or a value representing the allocation of the bandwidth for communication. The control device 2 transmits instruction data as downlink data used for controlling the control target device 4 to a following first communication device 3. Specifically, the control device 2 transmits the instruction data in downlink to the control target device 4 so that the instruction data passes through the first communication devices 3 (the following first communication devices 3) disposed downstream of the control device 2.

The first communication devices 3 are each a switch. A first communication device 3-0 acquires the instruction data from the control device 2. The first communication device 3-0 transmits the instruction data in downlink to a first communication device 3-1. The first communication device 3-1 acquires the instruction data from the first communication device 3-0. The first communication device 3-1 transmits the instruction data in downlink to the control target device 4 so that the instruction data passes through the first communication devices 3 disposed downstream of the first communication device 3-1. Note that a plurality of control target devices 4 may be disposed following the first communication device 3 (end node) disposed at the most downstream.

The first communication device 3 disposed at the most downstream acquires from the control target device 4 the certain data transmitted in uplink as uplink data used for controlling the control target device 4. A first communication device 3-(n+1) (n is an integer of 0 or more) acquires from a first communication device 3-(n+2) the certain data transmitted in uplink from the control target device 4. The first communication device 3-(n+1) transmits to a first communication device 3-n the certain data transmitted in uplink from the control target device 4. The first communication device 3-0 transmits to the control device 2 the certain data transmitted in uplink from the control target device 4.

The control target device 4 is a device under control as defined. The control target device 4 is, for example, an IoT terminal or an industrial robot. The control target device 4 acquires from the first communication device 3 disposed at the most downstream the instruction data transmitted in downlink. The control target device 4 generates the certain data in accordance with the instruction data. For example, the control target device 4 generates sensor data as uplink data used for controlling the control target device 4. For example, the control target device 4 may generate moving image data having a predetermined frame rate as uplink data used for controlling the control target device 4.

The control target device 4 transmits uplink data used for controlling the control target device 4 to the first communication device 3 disposed at the most downstream. Specifically, the control target device 4 transmits the certain data such as sensor data or moving image data in uplink to the control device 2 as uplink data used for controlling the control target device 4.

Next, the details of the first communication device 3 will be described.

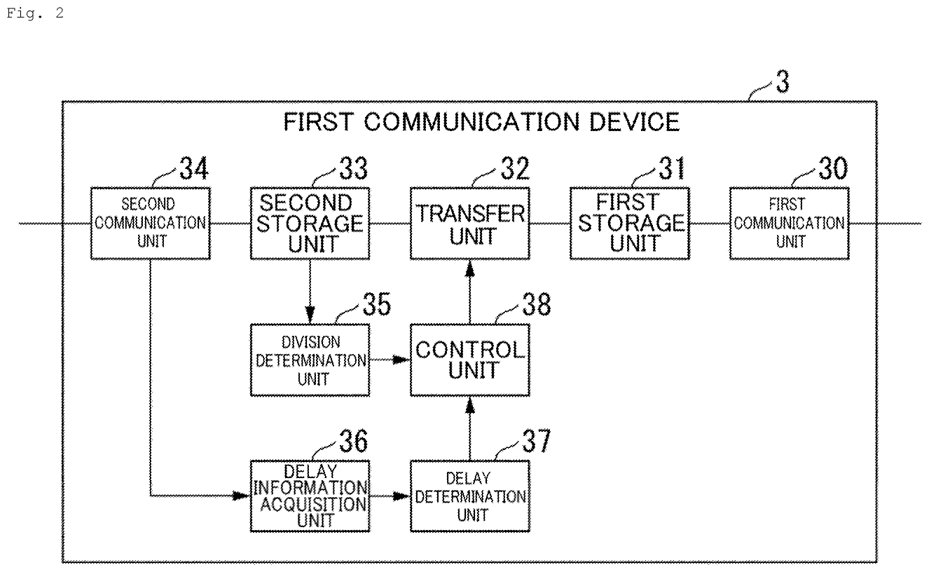

FIG. 2 is a diagram illustrating a configuration example of the first communication device 3 according to the first embodiment. The first communication device 3 includes a first communication unit 30 (transfer interface), a first storage unit 31, a transfer unit 32, a second storage unit 33 (buffer), a second communication unit 34 (transfer interface), a division determination unit 35, a delay information acquisition unit 36, a delay determination unit 37, and a control unit 38.

The first communication unit 30 of a first communication unit 30-0 acquires from the control device 2 the packet containing the instruction data transmitted in downlink. The first communication unit 30 of the first communication device 3-(n+1) acquires from the first communication device 3-n the packet containing the instruction data transmitted in downlink. The first communication unit 30 records in the first storage unit 31 the packet containing the instruction data transmitted in downlink.

The first communication unit 30 acquires from the first storage unit 31 the packet containing the certain data transmitted in uplink. The first communication unit 30 of the first communication device 3-(n+1) transmits to the first communication device 3-n the packet containing the certain data transmitted in uplink. The first communication unit 30 of the first communication unit 30-0 transmits to the control device 2 the packet containing the certain data transmitted in uplink.

The first storage unit 31 stores the packet containing the instruction data transmitted in downlink from the first communication unit 30. The first storage unit 31 stores the packet containing the certain data transmitted in uplink from the transfer unit 32.

The transfer unit 32 acquires from the control unit 38 information on a packet size determined by the control unit 38. The transfer unit 32 generates a packet having the size determined by the control unit 38.

The transfer unit 32 acquires from the first storage unit 31 the packet containing the instruction data transmitted in downlink. The transfer unit 32 includes in the generated packet the instruction data transmitted in downlink. The transfer unit 32 records in the second storage unit 33 the generated packet containing the instruction data transmitted in downlink.

The transfer unit 32 acquires from the second storage unit 33 the packet containing the certain data transmitted in uplink. The transfer unit 32 includes in the generated packet the certain data transmitted in uplink. The transfer unit 32 records in the first storage unit 31 the generated packet containing the certain data transmitted in uplink.

The second storage unit 33 stores the packet containing the instruction data transmitted in downlink from the transfer unit 32. The second storage unit 33 stores the packet containing the certain data transmitted in uplink from the second communication unit 34.

The second communication unit 34 acquires from the second storage unit 33 the packet containing the instruction data transmitted in downlink. The second communication unit 34 of the first communication device 3-n transmits to the first communication device 3-(n+1) the packet containing the instruction data transmitted in downlink.

The second communication unit 34 of the first communication device 3-n acquires from the first communication device 3-(n+1) the packet containing the certain data transmitted in uplink. The second communication unit 34 records in the second storage unit 33 the packet containing the certain data transmitted in uplink. The second communication unit 34 transmits to the delay information acquisition unit 36 the packet containing the certain data transmitted in uplink.

The division determination unit 35 acquires from the second storage unit 33 the packet containing the instruction data transmitted in downlink. The division determination unit 35 determines whether or not the instruction data used for controlling the control target device 4 per a certain cycle (e.g., packet transmission cycle) has been divided into a plurality of cycles. The division determination unit 35 transmits to the control unit 38 a determination result indicating whether or not the instruction data has been divided into a plurality of cycles.

The division determination unit 35 acquires from the second storage unit 33 the packet containing the certain data transmitted in uplink. The division determination unit 35 determines whether or not the size of the data used for control is within the packet size. Specifically, the division determination unit 35 determines whether or not the certain data used for controlling the control target device 4 per a certain cycle (e.g., packet transmission cycle) has been divided into a plurality of cycles. The division determination unit 35 transmits to the control unit 38 a determination result indicating whether or not the certain data has been divided into a plurality of cycles.

The delay information acquisition unit 36 and the delay determination unit 37 (time delay monitoring unit) measure the time delay in the entire control system 1a. The method for measuring the time delay in the entire control system 1a is not limited to a specific method. For example, the delay information acquisition unit 36 and the delay determination unit 37 measure the time delay in the communication processing of the entire control system 1a by using the control method disclosed in a reference (Japanese Patent Application Publication No. 2020-21410).

For example, the delay information acquisition unit 36 of the first communication device 3-n measures the time delay in the communication processing of the entire control system 1a based on the total of processing times in communication processing of one or more first communication devices 3 (the following first communication devices 3) disposed downstream of the first communication device 3-n. The delay information acquisition unit 36 acquires delay information indicating the time delay in communication processing from the one or more first communication devices 3 disposed downstream of the first communication device 3-n. Here, the delay information acquisition unit 36 acquires from the second communication unit 34 the packet containing the certain data transmitted in uplink. The delay information acquisition unit 36 sequentially measures the processing time in communication processing based on time information included in the header of the packet of the certain data transmitted in uplink and the reception time of the packet of the certain data transmitted in uplink. The delay information acquisition unit 36 adds up the processing times in communication processing for the first communication devices 3 disposed downstream. The delay determination unit 37 acquires delay information indicating the total of time delays in communication processing from the delay information acquisition unit 36. The delay determination unit 37 determines whether or not the total of time delays indicated by the delay information exceeds a first threshold value. The first threshold is determined in advance. The delay determination unit 37 transmits to the control unit 38 a determination result indicating whether or not the total of time delays indicated by the delay information exceeds the first threshold value.

For example, the delay information acquisition unit 36 may sequentially measure the time delay in the communication processing of the entire control system 1a based on a round trip time (RTT) of a signal transmitted to the first communication device 3 disposed at the most downstream. The delay information acquisition unit 36 sequentially measures the round trip time based on time information included in the header of the packet of the certain data transmitted in uplink and the reception time of the packet of the certain data transmitted in uplink. The delay determination unit 37 acquires from the delay information acquisition unit 36 the round trip time as the delay information indicating the time delay in communication processing. The delay determination unit 37 determines whether or not the time delay (round trip time) indicated by the delay information exceeds the first threshold value. The delay determination unit 37 transmits to the control unit 38 a determination result indicating whether or not the time delay indicated by the delay information exceeds the first threshold value.

The control unit 38 acquires from the division determination unit 35 a determination result indicating whether or not the certain data has been divided into a plurality of cycles. When it is determined that the certain data has been divided into a plurality of cycles, the control unit 38 sets the packet size to be increased so that at least one of the time delay and the jitter of the time delay is reduced. The control unit 38 transmits information on the packet size to the transfer unit 32.

The control unit 38 may acquire from the delay determination unit 37 a determination result indicating whether or not the time delay indicated by the delay information exceeds the first threshold value. When it is determined that the time delay exceeds the first threshold value, the control unit 38 sets the packet size to be increased so that at least one of the time delay and the jitter of the time delay is reduced. The control unit 38 transmits information on the packet size to the transfer unit 32.

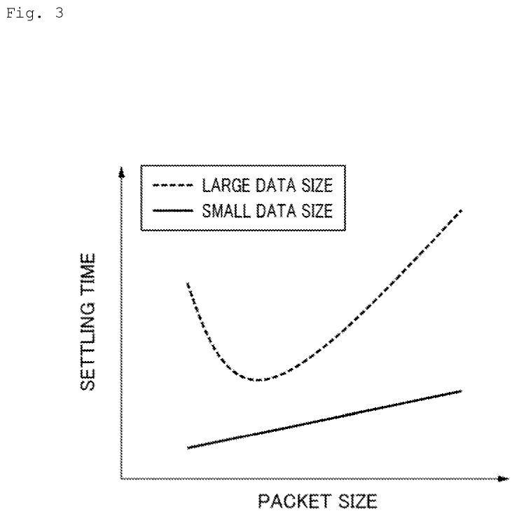

FIG. 3 illustrates an example of a relationship between packet size and settling time in the first embodiment. The horizontal axis represents packet size (network parameter). The vertical axis represents settling time of a control system in a communication network. In real-time control of IoT terminals, an increase in the time delay in communication processing leads to an increase in the settling time of a control system in a communication network. Therefore, the vertical axis may represent time delay.

If the size of the certain data transmitted in uplink is less than a threshold value (small data size), the smaller the size of the packet containing the certain data is, the shorter the settling time (time delay) in the entire communication network is.

If the size of the instruction data transmitted in downlink is less than a threshold value (small data size), the smaller the size of the packet containing the instruction data is, the shorter the settling time (time delay) in the entire communication network is.

If the size of the certain data transmitted in uplink is greater than or equal to the threshold value (large data size) and if the size of the packet containing the certain data is less than or equal to a predetermined size (too small packet size), the settling time (time delay) in the entire communication network is longer. This is because the certain data is divided into a plurality of packets, so that the time (time delay) required to receive all the certain data transmitted in uplink increases.

If the size of the instruction data transmitted in downlink is greater than or equal to the threshold value (large data size) and if the size of the packet containing the instruction data is less than or equal to a predetermined size (too small packet size), the settling time (time delay) in the entire communication network is longer. This is because the instruction data is divided into a plurality of packets, so that the time (time delay) required to receive all the instruction data transmitted in downlink increases.

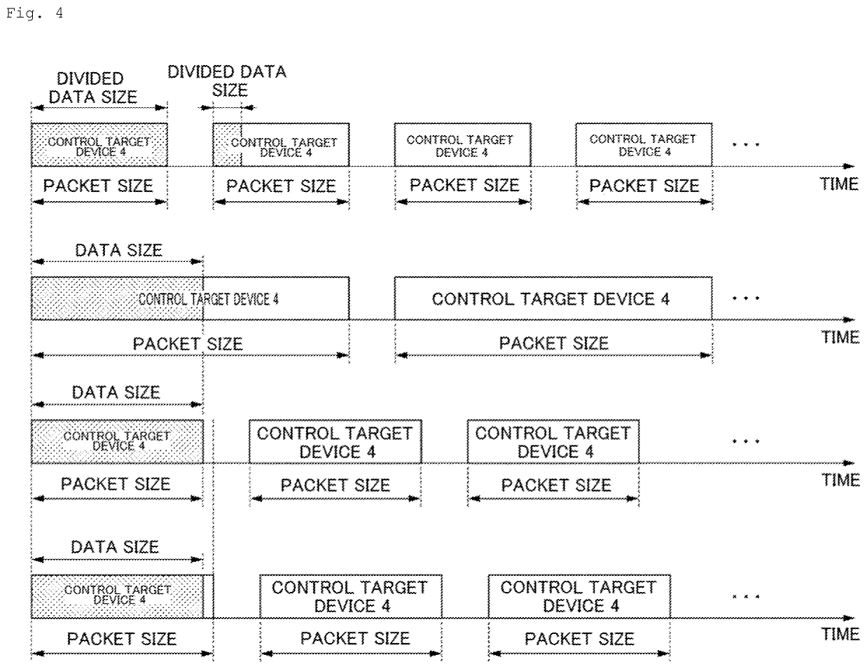

FIG. 4 illustrates an example of a relationship between data size and packet size in the first embodiment. The horizontal axis represents time. As illustrated in the first row from the top of FIG. 4, if the size of data used for control per a cycle (e.g., packet transmission cycle) is greater than the packet size, the data required for control per a cycle is divided into a plurality of packets. The data required for control per a cycle cannot be acquired by one packet received, so that the time (time delay) required to receive all the data required for control increases.

When it is determined that the time delay exceeds the first threshold value, the control unit 38 sets the packet size to be increased to be greater than the data size, as illustrated in the second row from the top of FIG. 4. The control unit 38 transmits information on the packet size to the transfer unit 32. As a result, the data required for control per a cycle can be acquired by one packet received, so that at least one of the time delay and the jitter of the time delay is reduced.

The control unit 38 may periodically reduce the packet size by a predetermined size. The control unit 38 determines whether or not at least one of the time delay and the jitter of the time delay increases when the packet size is periodically reduced. When it is determined that at least one of the time delay and the jitter of the time delay increases, the control unit 38 returns the packet size to the original size.

When it is determined that the time delay exceeds the first threshold value, the control unit 38 derives an appropriate size for the packet (data size) by using, for example, the gradient method, as illustrated in the third row from the top of FIG. 4, so that at least one of the time delay and the jitter of the time delay is reduced. The control unit 38 transmits information of the appropriate size for the packet to the transfer unit 32. This makes it possible to dynamically respond to changes in the status of the communication network.

When jitter occurs for the size of the data used for control per a cycle, the control unit 38 may increase the packet size to give a margin to the packet size, as illustrated in the fourth row from the top of FIG. 4. When jitter exceeding a predetermined threshold value “p” occurs with a certain probability “a” or more, the control unit 38 sets the packet size length “1” to be increased to give a margin to the packet size length. This makes it possible to reduce the time delay even when jitter occurs for the size of the data used for control per a cycle.

Next, an operation example of the control system 1a will be described.

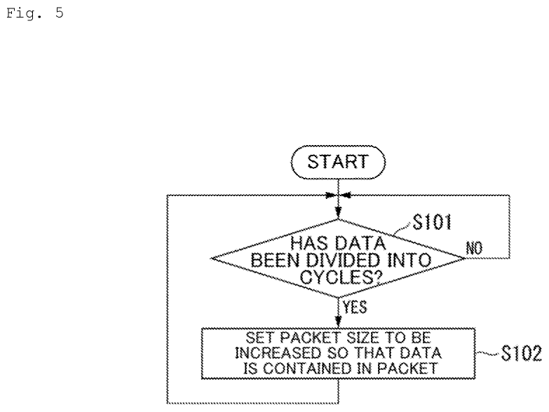

FIG. 5 is a flowchart illustrating the operation example of the control system 1a according to the first embodiment. The division determination unit 35 determines whether or not the data used for controlling the control target device 4 per a certain cycle has been divided into a plurality of cycles (step S101). The certain cycle is, for example, a packet transmission cycle.

When it is determined that the data has not been divided into a plurality of cycles (step S101: NO), the division determination unit 35 executes the operation of step S101 again after a predetermined time shorter than the packet transmission cycle elapses. When it is determined that the data has been divided into a plurality of cycles (step S101: YES), the control unit 38 sets the packet size to be increased so that the data required for control per cycle is contained in the packet (step S102). The control unit 38 returns the processing to step S101.

As described above, the division determination unit 35 determines whether or not the data (at least one of the instruction data and the certain data) used for controlling the control target device 4 per a certain cycle (e.g., packet transmission cycle) has been divided into a plurality of cycles. When it is determined that the data used for control per cycle has been divided, the control unit 38 sets the packet size to be increased so that the data required for control per cycle is contained in the packet.

In this way, the control unit 38 changes the packet size so that the data required for control per cycle is contained in the packet. As a result, the data required for control per cycle can be received at one time, so that it is possible to reduce at least one of the time delay in communication processing and the jitter of the time delay in a communication network such as a single star network. It is also possible to improve the accuracy of the control of the IoT terminal so that the IoT terminal is not out of control.

### Second Embodiment

A second embodiment is mainly different from the first embodiment in that the control system includes a second communication device and a third communication device. For the second embodiment, the differences from the first embodiment will be mainly described.

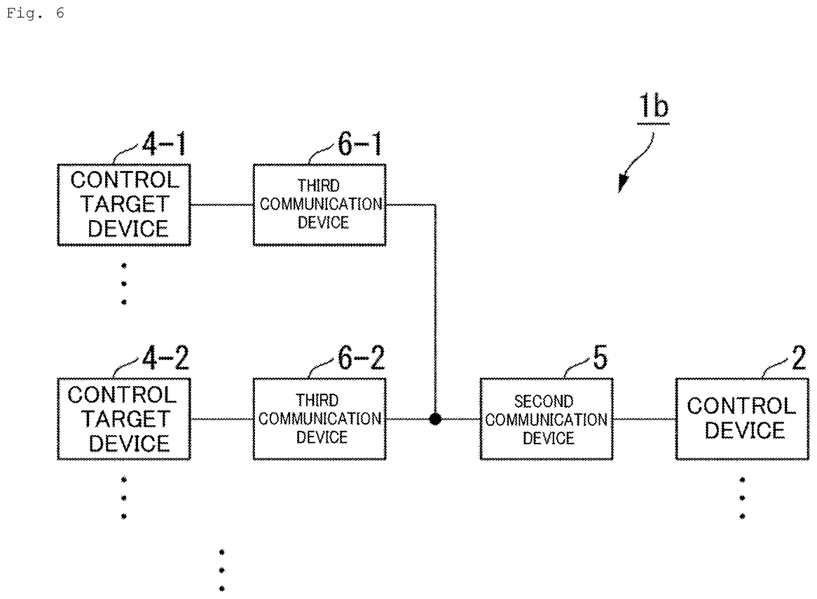

FIG. 6 is a diagram illustrating a configuration example of a control system 1b according to the second embodiment. The control system 1b is a system that executes real-time control of a control target device such as an IoT terminal. The control system 1b executes motion control of the control target device in real time.

The control system 1b includes one or more control devices 2, a second communication device 5, one or more third communication devices 6, and one or more control target devices 4. In the second embodiment, the control device 2, the second communication device 5, the one or more third communication devices 6, and the one or more control target devices 4 form an optical access network such as PON (Passive Optical Network).

The control device 2 is a device that controls the control target devices 4. The control device 2 acquires from the second communication device 5 certain data transmitted in uplink from the control target devices 4 as uplink data used for controlling the control target devices 4.

The control device 2 transmits instruction data as downlink data used for controlling the control target device 4 to the following second communication device 5. Specifically, the control device 2 transmits the instruction data to the control target devices 4 in downlink so that the instruction data passes through the second communication device 5 and the third communication devices 6, which are disposed downstream of the control device 2.

The second communication device 5 is an optical line terminal (OLT). The second communication device 5 is installed in, for example, a station building. The second communication device 5 acquires the instruction data from the control device 2. The second communication device 5 transmits the instruction data in downlink to the third communication devices 6. Specifically, the second communication device 5 transmits the instruction data in downlink to the control target devices 4 so that the instruction data passes through an optical fiber and the third communication devices 6 disposed downstream of the second communication device 5.

The second communication device 5 acquires, from each of the third communication devices 6 (the following each third communication device 6) disposed downstream of the second communication device 5, the certain data transmitted in uplink as uplink data used for controlling the control target device 4. The second communication device 5 transmits to the control device 2 the certain data transmitted in uplink from the control target device 4.

The third communication devices 6 are each an optical network unit (ONU). Each third communication device 6 is installed in, for example, each subscriber's house (customer's house). The third communication device 6 acquires the instruction data addressed to a following control target device 4 from the second communication device 5. A third communication device 6-n (n≥1) transmits the instruction data in downlink to a control target device 4-n (n≥1). Specifically, the third communication device 6 transmits the instruction data in downlink to the control target device 4 (the following control target device 4) disposed downstream of the third communication device 6. Note that, for each third communication device 6, a plurality of control target devices 4 may follow the third communication device 6.

The third communication device 6 acquires, from the control target device 4 disposed downstream of the third communication device 6, the certain data transmitted in uplink as uplink data used for controlling the control target device 4. The third communication device 6 transmits to the second communication device 5 the certain data transmitted in uplink from the control target device 4.

The control target devices 4 are each a device under control as defined. A control target device 4-m (m is an integer of 1 or more) acquires from a third communication device 6-m the instruction data transmitted in downlink. The control target device 4 generates the certain data in accordance with the instruction data.

The control target device 4-m transmits to the third communication device 6-m uplink data used for controlling the control target device 4-m. Specifically, the control target device 4 transmits the certain data such as sensor data or moving image data in uplink to the control device 2 as uplink data used for controlling the control target device 4.

Next, the details of the second communication device 5 will be described.

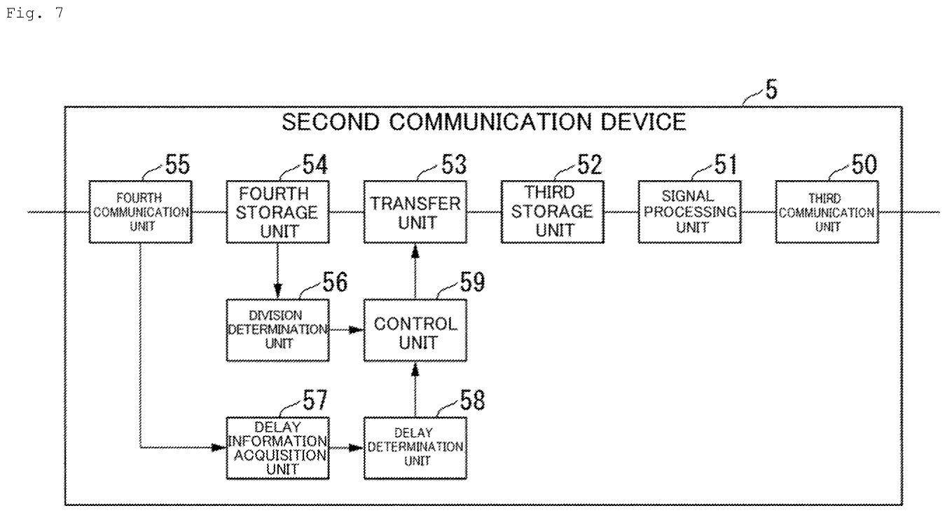

FIG. 7 is a diagram illustrating a configuration example of the second communication device 5 according to the second embodiment. The first communication device 3 includes a third communication unit 50 (optical communication unit), a signal processing unit 51, a third storage unit 52, a transfer unit 53, a fourth storage unit 54 (buffer), a fourth communication unit 55 (optical communication unit), a division determination unit 56, a delay information acquisition unit 57, a delay determination unit 58, and a control unit 59.

The third communication unit 50 acquires from the control device 2 a burst frame (continuous frame) including the instruction data transmitted in downlink. The third communication unit 50 transmits to the signal processing unit 51 the burst frame including the instruction data transmitted in downlink.

The third communication unit 50 acquires from the signal processing unit 51 a burst frame including the certain data transmitted in uplink. The third communication unit 50 transmits to the control device 2 the burst frame including the certain data transmitted in uplink.

The signal processing unit 51 executes predetermined signal processing. The predetermined signal processing is, for example, dynamic bandwidth allocation (DBA) processing for each third communication device 6. The signal processing unit 51 includes in the instruction data the execution result of the predetermined signal processing. The signal processing unit 51 acquires from the third communication unit 50 the burst frame including the instruction data transmitted in downlink. The signal processing unit 51 records in the third storage unit 52 the burst frame including the instruction data transmitted in downlink.

The signal processing unit 51 acquires from the third storage unit 52 the burst frame including the certain data transmitted in uplink. The signal processing unit 51 transmits to the third communication unit 50 the burst frame including the certain data transmitted in uplink.

The third storage unit 52 stores the burst frame including the instruction data transmitted in downlink from the signal processing unit 51. The third storage unit 52 stores the burst frame including the certain data transmitted in uplink from the transfer unit 53.

The transfer unit 53 acquires information on a burst frame length determined by the control unit 59 from the control unit 59. The transfer unit 53 generates a burst frame having the length determined by the control unit 59.

The transfer unit 53 acquires from the fourth storage unit 54 the burst frame including the certain data transmitted in uplink. The transfer unit 53 includes in the generated burst frame the certain data transmitted in uplink. The transfer unit 53 records in the third storage unit 52 the generated burst frame including the certain data transmitted in uplink.

The fourth storage unit 54 stores the burst frame including instruction data transmitted in downlink from the transfer unit 53. The fourth storage unit 54 stores the burst frame including the certain data transmitted in uplink from the fourth communication unit 55.

The fourth communication unit 55 acquires from the fourth storage unit 54 the burst frame including the instruction data transmitted in downlink. The fourth communication unit 55 transmits to each third communication device 6 the burst frame including the instruction data transmitted in downlink. In the header of the burst frame including the instruction data, identification information of the control target device 4 which is the destination of the instruction data is described.

The fourth communication unit 55 acquires from the third communication device 6 the burst frame including the certain data transmitted in uplink. The fourth communication unit 55 records in the fourth storage unit 54 the burst frame including the certain data transmitted in uplink. The fourth communication unit 55 transmits to the delay information acquisition unit 57 the burst frame including the certain data transmitted in uplink.

The division determination unit 56 acquires from the fourth communication unit 55 the burst frame including the instruction data transmitted in downlink. The division determination unit 56 determines whether or not the instruction data used for controlling the control target device 4 per a certain cycle (e.g., burst frame transmission cycle) has been divided into a plurality of cycles. The division determination unit 56 transmits to the control unit 59 a determination result indicating whether or not the instruction data has been divided into a plurality of cycles.

The division determination unit 56 acquires from the fourth communication unit 55 the burst frame including the certain data transmitted in uplink. The division determination unit 35 determines whether or not the size of the data used for control is within the burst frame length. Specifically, the division determination unit 35 determines whether or not the certain data used for controlling the control target device 4 per a certain cycle (e.g., burst frame transmission cycle) has been divided into a plurality of cycles. The division determination unit 56 transmits to the control unit 59 a determination result indicating whether or not the certain data has been divided into a plurality of cycles.

The delay information acquisition unit 57 and the delay determination unit 58 (time delay monitoring unit) measure the time delay in the entire control system 1b. The method for measuring the time delay in the entire control system 1b is not limited to a specific method. For example, the delay information acquisition unit 57 and the delay determination unit 58 measure the time delay in the communication processing of the entire control system 1b by using the control method disclosed in a reference (Japanese Patent Application Publication No. 2020-21410).

For example, the delay information acquisition unit 57 measures the time delay in the communication processing of the entire control system 1b based on the processing time in the communication processing of the following third communication device(s) 6. The delay information acquisition unit 57 acquires delay information indicating the time delay in communication processing from the third communication device 6. Here, the delay information acquisition unit 57 acquires from the fourth communication unit 55 the burst frame including the certain data transmitted in uplink. The delay information acquisition unit 57 sequentially measures the processing time in communication processing based on time information included in the header of the burst frame of the certain data transmitted in uplink and the reception time of the burst frame of the certain data transmitted in uplink. The delay determination unit 58 acquires delay information indicating the time delay in communication processing from the delay information acquisition unit 57. The delay determination unit 58 determines whether or not the time delay indicated by the delay information exceeds a first threshold value. The delay determination unit 58 transmits to the control unit 59 a determination result indicating whether or not the time delay indicated by the delay information exceeds the first threshold value.

For example, the delay information acquisition unit 57 may sequentially measure the time delay in the communication processing of the entire control system 1b based on a round trip time of an optical signal transmitted to the following third communication device(s) 6. The delay information acquisition unit 57 sequentially measures the round trip time based on time information included in the header of the burst frame of the certain data transmitted in uplink and the reception time of the burst frame of the certain data transmitted in uplink. The delay determination unit 58 acquires from the delay information acquisition unit 57 the round trip time as the delay information indicating the time delay in communication processing. The delay determination unit 58 determines whether or not the time delay (round trip time) indicated by the delay information exceeds the first threshold value. The delay determination unit 58 transmits to the control unit 59 a determination result indicating whether or not the time delay indicated by the delay information exceeds the first threshold value.

The control unit 59 acquires from the division determination unit 56 a determination result indicating whether or not the certain data has been divided into a plurality of cycles. When it is determined that the certain data has been divided into a plurality of cycles, the control unit 59 sets the burst frame length to be increased so that at least one of the time delay and the jitter of the time delay is reduced. The control unit 59 transmits information on the burst frame length to the transfer unit 53.

The control unit 59 may acquire from the delay determination unit 58 a determination result indicating whether or not the time delay indicated by the delay information exceeds the first threshold value. When it is determined that the time delay exceeds the first threshold value, the control unit 59 sets the burst frame length to be increased so that at least one of the time delay and the jitter of the time delay is reduced. The control unit 38 transmits information on the burst frame length to the transfer unit 53.

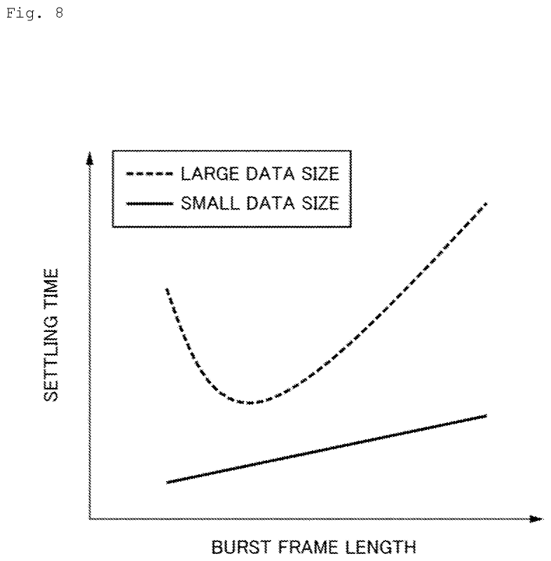

FIG. 8 illustrates an example of a relationship between burst frame size and settling time in the second embodiment. The horizontal axis represents burst frame size (network parameter). The vertical axis represents settling time of a control system in a communication network. The vertical axis may represent time delay.

If the size of the certain data transmitted in uplink is greater than or equal to the threshold value (large data size) and if the size of the burst frame containing the certain data is less than or equal to a predetermined size (too small burst frame length), the time delay in the communication processing of the entire communication network is longer. This is because, due to the certain data being divided into a plurality of burst frames, it takes time to receive the certain data transmitted in uplink.

If the size of the instruction data transmitted in downlink is greater than or equal to the threshold value (large data size) and if the size of the burst frame containing the instruction data is less than or equal to a predetermined size (too small burst frame length), the time delay in the communication processing of the entire communication network is longer. This is because, due to the instruction data being divided into a plurality of burst frames, it takes time to receive the instruction data transmitted in downlink.

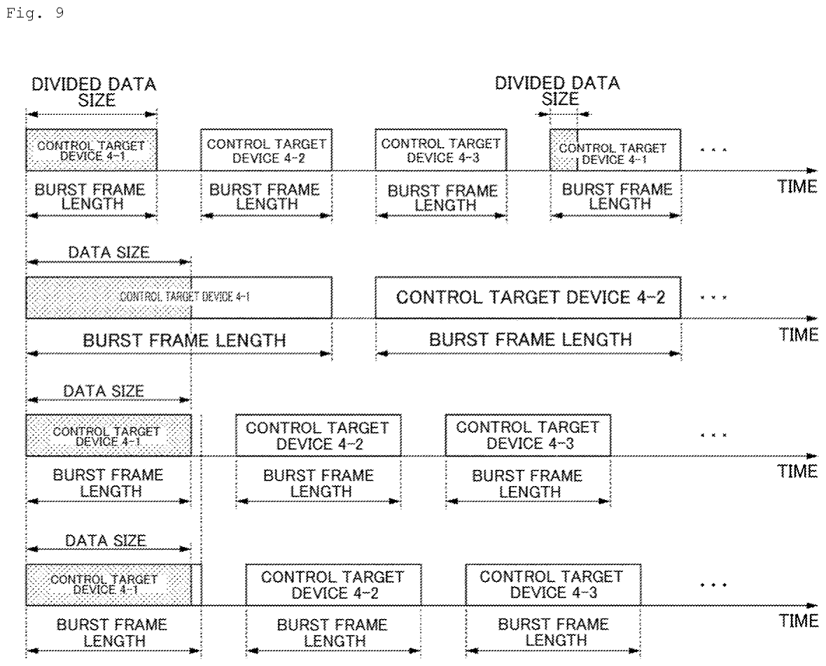

FIG. 9 illustrates an example of a relationship between data size and burst frame size in the second embodiment. The horizontal axis represents time. As illustrated in the first row from the top of FIG. 9, if the size (length) of the data used for control per a cycle (e.g., burst frame transmission cycle) is longer than the length of the burst frame, the data required for control per a cycle is divided into a plurality of burst frames. The data required for control per a cycle cannot be acquired by one burst frame received, so that the time (time delay) required to receive all the data required for control increases.

When it is determined that the time delay exceeds the first threshold value, the control unit 59 increases the burst frame length to be greater than the data size, as illustrated in the second row from the top of FIG. 9. The control unit 59 transmits information on the burst frame length to the transfer unit 53. As a result, the data required for control per a cycle can be acquired by one burst frame received, so that at least one of the time delay and the jitter of the time delay is reduced.

The control unit 59 may periodically reduce the burst frame length by a predetermined length. The control unit 59 determines whether or not at least one of the time delay and the jitter of the time delay increases when the burst frame length is periodically reduced. When it is determined that at least one of the time delay and the jitter of the time delay decreases, the control unit 59 returns the burst frame length to the original length.

When it is determined that the time delay exceeds the first threshold value, the control unit 59 derives an appropriate length for the burst frame (data size) by using, for example, the gradient method, as illustrated in the third row from the top of FIG. 9, so that at least one of the time delay and the jitter of the time delay is reduced. The control unit 59 transmits information on the appropriate length for the burst frame to the transfer unit 53. This makes it possible to dynamically respond to changes in the status of the communication network.

When jitter occurs for the size of the data used for control per a cycle, the control unit 59 may increase the burst frame length to give a margin to the burst frame length, as illustrated in the fourth row from the top of FIG. 9. When jitter exceeding a predetermined threshold value “p” occurs with a certain probability “a” or more, the control unit 59 sets the burst frame length “1” to be increased to give a margin to the burst frame length. This makes it possible to reduce the time delay even when jitter occurs for the size of the data used for control per a cycle.

Next, an operation example of the control system 1b will be described.

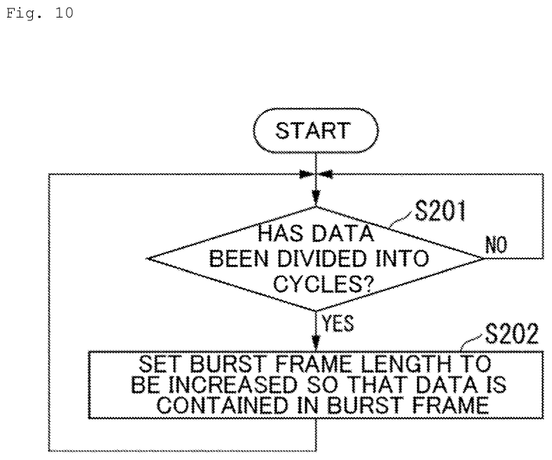

FIG. 10 is a flowchart illustrating the operation example of the control system 1b according to the second embodiment. The division determination unit 56 determines whether or not the data used for controlling the control target device 4 per a certain cycle has been divided into a plurality of cycles (step S201). The certain cycle is, for example, a burst frame transmission cycle.

When it is determined that the data has not been divided into a plurality of cycles (step S201: NO), the division determination unit 56 executes the operation of step S201 again after a predetermined time shorter than the burst frame transmission cycle elapses. When it is determined that the data has been divided into a plurality of cycles (step S201: YES), the control unit 59 sets the burst frame length to be increased so that the data required for control per cycle is contained in the packet (step S202). The control unit 59 returns the processing to step S201.

As described above, the division determination unit 35 determines whether or not the data (at least one of the instruction data and the certain data) used for controlling the control target device 4 per a certain cycle (e.g., burst frame transmission cycle) has been divided into a plurality of cycles. When it is determined that the data used for control per cycle has been divided, the control unit 38 sets the burst frame length to be increased so that the data required for control per cycle is contained in the burst frame.

In this way, the control unit 38 changes the burst frame length so that the data required for control per cycle is contained in the burst frame. As a result, the data required for control per cycle can be received at one time, so that it is possible to reduce at least one of the time delay in communication processing and the jitter of the time delay in an optical access network such as PON. It is also possible to improve the accuracy of the control of the IoT terminal so that the IoT terminal is not out of control.

### Third Embodiment

A third embodiment is mainly different from the first embodiment and the second embodiment in that the control system includes a first communication device, a second communication device, and a third communication device. For the third embodiment, the differences from the first embodiment and the second embodiment will be mainly described.

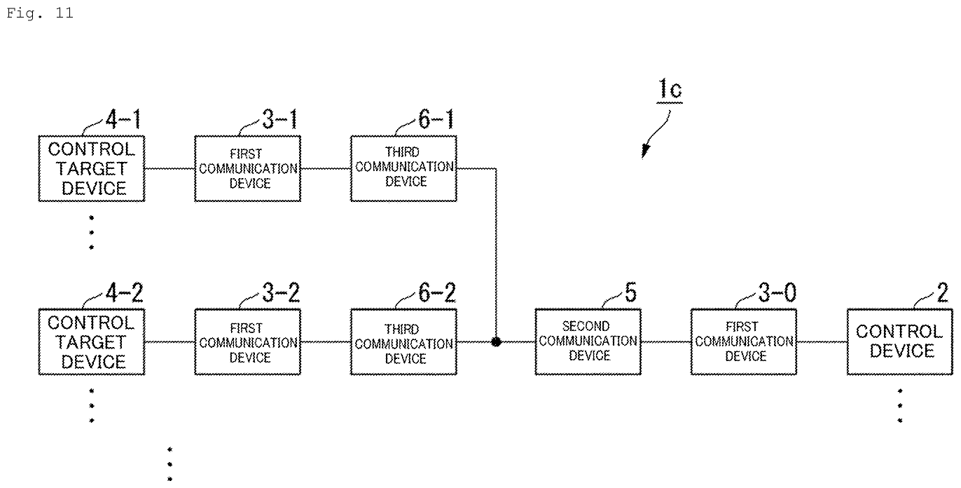

FIG. 11 is a diagram illustrating a configuration example of a control system 1c according to the third embodiment. The control system 1c is a system that executes real-time control of a control target device such as an IoT terminal. The control system 1c executes motion control of the control target device in real time.

The control system 1c includes one or more control devices 2, a plurality of first communication devices 3, a second communication device 5, one or more third communication devices 6, and one or more control target devices 4. In the third embodiment, the control device 2, the plurality of first communication devices 3, the second communication device 5, the one or more third communication devices 6, and the one or more control target devices 4 form an optical access network such as PON.

The control device 2 is a device that controls the control target devices 4. The control device 2 acquires from a first communication device 3-0 certain data transmitted in uplink from the control target devices 4 as uplink data used for controlling the control target devices 4.

The control device 2 transmits instruction data as downlink data used for controlling the control target device 4 to the following first communication device 3-0. Specifically, the control device 2 transmits the instruction data in downlink to the control target devices 4 so that the instruction data passes through the first communication devices 3, the second communication device 5, and the third communication devices 6, which are disposed downstream of the control device 2.

The first communication devices 3 are each a switch. The first communication device 3-0 acquires the instruction data from the control device 2. The first communication device 3-0 transmits the instruction data in downlink to the second communication device 5.

The first communication device 3-0 acquires from the second communication device 5 the certain data transmitted in uplink from the control target device 4. The first communication device 3-0 transmits to the control device 2 the certain data transmitted in uplink from the control target device 4.

The second communication device 5 is an optical line terminal. The second communication device 5 acquires the instruction data from the first communication device 3-0. The second communication device 5 transmits the instruction data in downlink to the third communication devices 6. Specifically, the second communication device 5 transmits the instruction data in downlink to the control target devices 4 so that the instruction data passes through an optical fiber, the first communication devices 3, and the third communication devices 6, which are disposed downstream of the second communication device 5.

The second communication device 5 acquires, from each of the third communication devices 6 (the following each third communication device 6) disposed downstream of the second communication device 5, the certain data transmitted in uplink as uplink data used for controlling the control target device 4. The second communication device 5 transmits to the first communication device 3-0 the certain data transmitted in uplink from the control target device 4.

The third communication devices 6 are each an optical network unit. The third communication device 6 acquires the instruction data addressed to the following control target device 4 from the second communication device 5. A third communication device 6-n (n≥1) transmits the instruction data in downlink to a first communication device 3-n (n≥1). Specifically, the third communication device 6 transmits the instruction data in downlink to the control target device 4 (the following control target device 4) disposed downstream of the third communication device 6.

The third communication device 6-n (n≥1) acquires, from the first communication device 3-n (n≥1) disposed downstream of the third communication device 6-n (n≥1), the certain data transmitted in uplink as uplink data used for controlling a control target device 4-n (n≥1). The third communication device 6 transmits to the second communication device 5 the certain data transmitted in uplink from the control target device 4.

The first communication device 3-n (n≥1) acquires the instruction data from the third communication device 6-n. The first communication device 3-n (n≥1) transmits the instruction data in downlink to the control target device 4-n. Note that, for each first communication device 3-n (n≥1), a plurality of control target devices 4 may follow the first communication device 3-n (n≥1).

The first communication device 3-n (n≥1) acquires from the control target device 4-n the certain data transmitted in uplink as uplink data used for controlling the control target device 4. The first communication device 3-n (n≥1) transmits to the third communication device 6-n the certain data transmitted in uplink from the control target device 4-n.

The control target devices 4 are each a device under control as defined. A control target device 4-m acquires from a first communication device 3-m the instruction data transmitted in downlink. The control target device 4 generates the certain data in accordance with the instruction data.

The control target device 4-m transmits to the first communication device 3-m uplink data used for controlling the control target device 4-m. Specifically, the control target device 4 transmits the certain data such as sensor data or moving image data in uplink to the control device 2 as uplink data used for controlling the control target device 4.

As described above, the division determination unit 35 determines whether or not the data (at least one of the instruction data and the certain data) used for controlling the control target device 4 per a certain cycle has been divided into a plurality of cycles. When it is determined that the data used for control per cycle has been divided, the control unit 38 sets the packet size to be increased so that the data required for control per cycle is contained in the packet. When it is determined that the data used for control per cycle has been divided, the control unit 38 sets the burst frame length to be increased so that the data required for control per cycle is contained in the burst frame.

In this way, the control unit 38 changes at least one of the packet size and the burst frame length. As a result, the data required for control per cycle can be received at one time, so that it is possible to reduce at least one of the time delay in communication processing and the jitter of the time delay in a single star network or an optical access network. It is also possible to improve the accuracy of the control of the IoT terminal so that the IoT terminal is not out of control.

Part or all of the devices of the control system are realized as software by a processor, such as a CPU (Central Processing Unit), executing a program stored in a storage unit including a non-volatile recording medium (non-transitory recording medium). The program may be recorded on a computer-readable recording medium. The computer-readable recording medium is a non-transitory recording medium, for example, a portable medium such as a flexible disk, an optical magnetic disk, a portable medium, an ROM (Read Only Memory) or a CD-ROM (Compact Disc Read Only Memory), or a storage device such as a hard disk built in computer system.

Part or all of the devices of the control system may be implemented using hardware including an electronic circuit or circuitry using, for example, LSI (Large Scale Integration circuit), ASIC (Application Specific Integrated Circuit), PLD (Programmable Logic Device), FPGA (Field Programmable Gate Array), or the like.

Although the embodiments of the present invention have been described in detail above with reference to the drawings, the specific configuration is not limited to such embodiments, and includes any designs and the like without departing from the spirit and scope of the present invention.

### INDUSTRIAL APPLICABILITY

The present invention is applicable to control systems such as IoT terminals and industrial robots.

### REFERENCE SIGNS LIST

1a, 1b, 1c Control system
2 Control device
3 First communication device
4 Control target device
5 Second communication device
6 Third communication device
30 First communication unit
31 First storage unit
32 Transfer unit
33 Second storage unit
34 Second communication unit
35 Division determination unit
36 Delay information acquisition unit
37 Delay determination unit
38 Control unit
50 Third communication unit
51 Signal processing unit
52 Third storage unit
53 Transfer unit
54 Fourth storage unit
55 Fourth communication unit
56 Division determination unit
57 Delay information acquisition unit
58 Delay determination unit
59 Control unit

1. A control system comprising:
a control device that controls a control target device; and
one or more communication devices that execute communication processing between the control target device and the control device, wherein
each of the communication devices includes
a processor; and
a storage medium having computer program instructions stored thereon, when executed by the processor, perform to:
determines whether data used for controlling the control target device per a certain cycle has been divided into a plurality of cycles each being the certain cycle; and
when it is determined that the data used for control per the cycle has been divided, sets a size of a packet to be increased so that data required for control per the cycle is contained in the packet, or sets a length of a burst frame to be increased so that data required for control per the cycle is contained in the burst frame.

2. The control system according to claim 1, wherein the computer program instructions further perform to
acquires delay information indicating a time delay in the communication processing from one or more other communication devices; and
determines whether the time delay indicated by the delay information exceeds a predetermined first threshold value, wherein
when it is determined that the time delay exceeds the first threshold value, sets the size of the packet or the length of the burst frame to be increased.

3. The control system according to claim 2, wherein the computer program instructions further perform to
sets the size of the packet to be increased when jitter exceeding a predetermined second threshold value for the size of the packet occurs in the time delay with a certain probability or more, or sets the length of the burst frame to be increased when jitter exceeding a predetermined third threshold value for a size of the burst frame occurs in the time delay with a certain probability or more.

4. The control system according to claim 1, wherein the computer program instructions further perform to
determines whether at least one of the time delay and jitter of the time delay increases when the size of the packet is periodically reduced, and returns the size of the packet to an original size when determining that the at least one of the time delay and jitter of the time delay increases, or
determines whether at least one of the time delay and jitter of the time delay increases when the length of the burst frame is periodically reduced, and returns the length of the burst frame to an original size when determining that the at least one of the time delay and jitter of the time delay increases.

5. A control method performed by a control system including a control device that controls a control target device, and one or more communication devices that execute communication processing between the control target device and the control device, the control method comprising:
a division determination step of, by each of the communication devices, determining whether data used for controlling the control target device per a certain cycle has been divided into a plurality of cycles each being the certain cycle; and
a control step of, by each of the communication devices, when it is determined that the data used for control per the cycle has been divided, setting a size of a packet to be increased so that data required for control per the cycle is contained in the packet, or setting a length of a burst frame to be increased so that data required for control per the cycle is contained in the burst frame.
